(19) United States
(12) Patent Application Publication
(10) Pub. No.: US 2010/0010860 A1
(43) Pub. Date: Jan. 14, 2010

(54) SYSTEM AND METHOD FOR SOCIAL NETWORK ROUTING FOR REQUEST MATCHING IN ENTERPRISE ENVIRONMENTS

(75) Inventors: Abhijit Bose, Paramus, NJ (US); Hani T. Jamjoom, White Plains, NY (US); Asheq Khan, Amherst, NY (US); Debanjan Saha, Mohegan Lake, NY (US); Zon-Yin Shae, South Salem, NY (US)

Correspondence Address: Ryan, Mason & Lewis, LLP, Suite 205, 1300 Post Road, Fairfield, CT, 06824, US

(73) Assignee: International Business Machines Corporation, Armonk, NY (US)

(21) Appl. No.: 12/172,637

(22) Filed: Jul. 14, 2008

(51) Int. Cl. G06Q 10/00

(52) U.S. Cl. 705/9; 705/8

(57) ABSTRACT

A plurality of requests for service are obtained, each of the requests specifying a description of work, at least one constraint, and at least one objective function. Each request is routed to a corresponding first target resource, according to a routing table, in a manner to satisfy the at least one constraint and the at least one objective function. Tracking is carried out to determine whether the first target resource accepts a given request, rejects the given request, or passes on the given request to a second resource. The routing table is updated based on the tracking.

### FIELD OF THE INVENTION

The present invention relates to the electrical, electronic and computer arts, and, more particularly, to handling service requests for computer systems and the like.

### BACKGROUND OF THE INVENTION

In an enterprise system, matching the right skills to a “service request” is a common everyday problem. The skill tracking system and competency structure maintained by a corporation fails to match smaller and loosely defined requests (usually common to problem tickets and change requests) to the right skills. As a consequence, with the exception of simple issues (like ‘password resets’), a request for service (RFS) usually traverses through multiple work-groups and subject matter experts (SMEs) within a work-group before it is resolved. Such a delay not only causes an increase in the request resolution time but, also translates into inefficient use of SME time and possible violation of service level agreements (SLAs). The long path (duration) that is taken by a request in order to be resolved can be attributed to two primary factors: first, the coarse granularity with which an RFS is labeled and subsequently routed to a work-group; and second, there is an absence of a mechanism that maintains and leverages historical routing information to accurately predict future routing. In the former case, incorporating a finer grain RFS labeling system requires a massive overhaul of the current routing architecture, which may not be feasible.

### SUMMARY OF THE INVENTION

Principles of the present invention provide techniques for social network routing for request matching in enterprise environments. In one aspect, an exemplary method (which can be computer implemented) for routing requests for service, includes the steps of obtaining a plurality of requests for service, each of the requests specifying a description of work, at least one constraint, and at least one objective function; routing each given one of the requests to a corresponding first target resource, according to a routing table, in a manner to satisfy the at least one constraint and the at least one objective function; tracking whether the first target resource accepts a given request, rejects the given request, or passes on the given request to a second resource; and updating the routing table based on the tracking step.

One or more embodiments of the invention or elements thereof can be implemented in the form of a computer product including a computer usable medium with computer usable program code for performing the method steps indicated. Furthermore, one or more embodiments of the invention or elements thereof can be implemented in the form of a system (or apparatus) including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include hardware module(s), software module(s), or a combination of hardware and software modules.

One or more embodiments of the invention may offer technical benefits such as the following benefit: ability to match the right skills to a ‘service request’ even when requests are (1) smaller and (2) loosely defined, which is common to problem tickets, change requests, and the like, and even in large enterprises where a request for service (RFS) has to touch many hands before being completed.

These and other features, aspects and advantages of the present invention will become apparent from the following detailed description of illustrative embodiments thereof, which is to be read in connection with the accompanying drawings.

### BRIEF DESCRIPTION OF THE DRAWINGS

FIG. 1 shows an exemplary system block diagram and processing flow, according to an aspect of the invention;

FIG. 2 shows a flow chart of exemplary method steps, according to another aspect of the invention; and

FIG. 3 depicts a computer system that may be useful in implementing one or more aspects and/or elements of the present invention.

### DETAILED DESCRIPTION OF PREFERRED EMBODIMENTS

In one or more embodiments of the invention, the attributes of historical requests can be leveraged to develop a routing system that can correctly identify both the work-group and the SME within the group that can resolve a new request in a timely manner.

One significant aspect of one or more embodiments of the invention is the modeling of the enterprise service-providing system as a “social network.” In one or more embodiments, this allows leveraging historical social interactions among SMEs and work-groups in resolving requests, so as to build a dynamic self-adaptive routing system, which can resolve a future RFS in a more timely manner. The routing system takes as input an RFS that includes a description of the “work order” and associated constraints (for example, expected date of completion, severity, and so on) and objective functions (for example, minimum resolution time, maximum resolution quality, and the like). The system then performs a look-up to identify a list of potential service providers; typically, work-groups or SMEs that will satisfy the pre-defined constraints and meet the objective functions. The routing system is initialized with the information available at the start-up, such as, for example, organizational and/or competency hierarchy, and self-assessment of skills by service providers. For instance, when an RFS for a network-related service arrives, it is routed to the network competency leader, who in turn routes it through the hierarchy, ultimately to the actual service providers. In essence, in one or more embodiments, the organizational knowledge about “who-can-do-what” is effectively employed to find the right service provider.

In one or more embodiments, a feed-back (“online-learning”) feature captures two time variance aspects of the system: (1) the skillfulness of each SME in resolving requests in various problem domains, and (2) the organizational knowledge of each SME in knowing SMEs and work-groups that may have the required skill to resolve a request. Over time, the organizational knowledge is “institutionalized” and more accurate request routing tables are formed. Accuracy of the routing table is further improved via feedback from service recipients as well as tracking of the RFSs through the system.

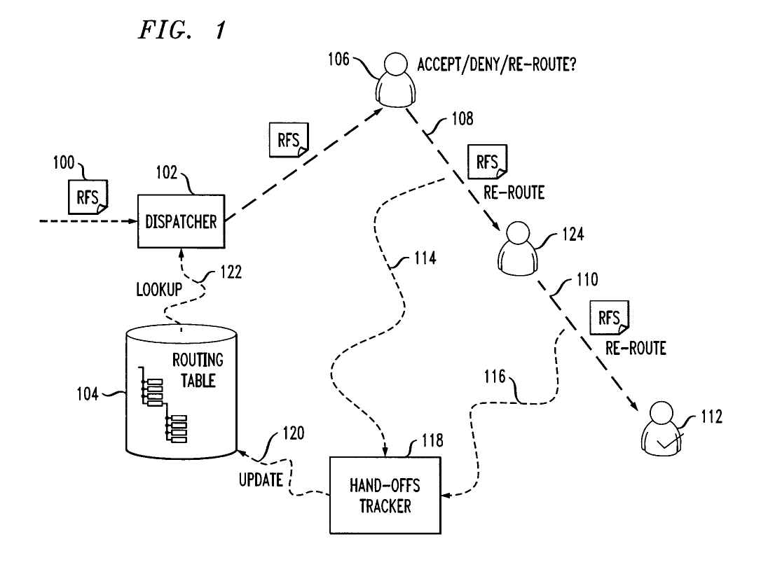

With attention now to FIG. 1, as a new RFS 100 arrives, the dispatcher 102 performs a lookup 122 into the routing table 104 to determine (i) the work-group and (ii) the SME within the work-group that can resolve the request according to the pre-defined constraints and objectives. In order to update the routing system with time, the system tracks an RFS as it is passed or handed-off from one SME to the next until it is resolved. Upon receiving an RFS, an SME 106 can choose to (i) accept it (in this case, some work is performed), (ii) reject it (in this case, he or she believes the request is not in his or her job responsibilities or area of expertise), or (iii) pass or re-route it (as shown at 108, 110) (in this case, he or she will also suggest one or more SMEs and/or work-groups that can perform the task). It is often the case that a request 100 requires the attention of several SMEs 106, 124, 112, each performing a subset of the necessary work. In one or more embodiments, when a request is ‘partially’ resolved, the SME 106 can ‘re-route it back’ to the dispatcher 102 or ‘re-route it forward’ to another SME 124, who, in turn, might re-route it again until it is resolved by a still further SME 112. Each re-route or hand-off 114, 116 of an RFS is recorded by the “hand-off track” module 118. Once an RFS 100 is resolved, information from the chain of hand-offs is applied to update the routing table 104, as shown by arrow 120.

Thus, in one or more embodiments, the routing table 104 updates both the skillfulness and organizational knowledge of each SME 106, 124, 112 who was involved in routing the RFS to a resolver (that is, a candidate work group and/or SME believed to be appropriate for resolution). The update credits an SME for each correct decision he or she made and penalizes him or her for incorrect routing decisions. The credits and penalties are weighted together to determine an SME's performance parameters at a particular instance in time.

Accordingly, one or more embodiments of the invention provide a system that maintains track of the paths taken by requests 100 as they are passed from one SME 106, 124 to the next SME 124, 112 (either due to the current SME's perception about the next SME possessing the right skill to resolve the request or due to the fact that additional work is required to complete the request), until the SME with required skill is found. The self-learning nature of the system applies the tracked information to automatically update the routing table 104 to efficiently route future requests of the same problem domain in a more timely manner (fewer hand-offs between SMEs).

Further, one or more embodiments of the invention provide a system that assigns weights to ‘key words’ within service requests. The weights are based on the probability that a specific SME 106, 124, 112 will not only know how to fulfill the request, but also route it to the right SME 124, 112 if he or she is the not the right person. Also provided in one or more embodiments is a system that adjusts the associated probabilities based on the stochastic nature of the work environment (for example, to provide load balancing, time-of-day availability, and so on). In some instances, the system adjusts the associated probabilities based on the expected completion time for the different routing options (for example, an SME having a higher experience level (so-called “band 8”) may perform the same task in half the time as an SME having a lower experience level (so-called “band 5”). Furthermore, in some instances, the system also captures cost (or a utility function) and tries to reduce or even minimize the expected cost.

In one or more embodiments, whenever a hand-off 114, 116 is registered, the system updates the assigned weights and/or probabilities based on the tracked dimensions; the result is not just a change in a single value, but rather in the underlying stochastic function. In another aspect, one or more inventive embodiments track out-of-order fulfillment of a given task and choose an appropriate ordering that reduces or minimizes the expected number of hand-offs.

By way of review and provision of further detail, one or more embodiments of the invention advantageously match the right skills to a ‘service request’ even when requests are (1) smaller and (2) loosely defined, which is common to problem tickets, change requests, and the like, and even in large enterprises where a request for service (RFS) has to touch many hands before being completed. One or more instances of the invention provide a solution that matches service requests to skills (individual or team) satisfying a set of constraints (for example, expertise level, location, availability, and the like) and objectives (cost, quality, and so on). One or more embodiments are self-learning in the sense that they start with the organizational structure as the initial “routing tree” and use the hierarchy to identify the right skills for the job. Over time, as one or more exemplary inventive systems learn about skills and expertise of people, they flatten the routing hierarchy and improve the accuracy of routing by reducing the number of hops it takes to find the right skills.

In one or more embodiments, a self-learning request for service (RFS) routing system takes as input an RFS 100 that contains a description of the “work order” and associated constraints (for example, date of completion, expected quality, and so on) and objective functions (for example, minimum cost). The output out of the routing system is a list of potential service providers such as individuals or teams, in order of preference, who would satisfy the constraints and the objective functions.

The routing system can be instantiated with whatever information is available at the startup, for example, organizational and/or competency hierarchy, and self-assessment of skills by service providers. When a request 100 comes, for, say, a network-related service, it is routed to a network competency leader, who in turn routes it through the hierarchy ultimately to the actual service provider(s). As time progresses and more and more requests 100 are routed through the system, the system learns about specific skills of service providers 106, 124, 112 as well as people with appropriate organizational knowledge (the routing nodes—people 106, 124, 112 may, in general represent people who can do some or all of the work, and/or people who know the right people to do some or all of the work). Over time, the organizational knowledge is “institutionalized” and flatter, more accurate routing tables 104 are formed. Accuracy of the routing table 104 is further improved via feedback from service recipients as well as via tracking of the RFSs 100 through the system.

With regard to ‘tracking’ how requests are passed or handed off from one person to the next to fulfill the request, assume, for purposes of illustration, that each worker has a work queue, where a request will arrive. When the request arrives, the worker can, as previously noted, choose to accept it, reject it, or pass it on. Requests often require the attention of several workers, each performing a subset of the necessary work. In at least some instances, when a request is ‘partially’ complete, the worker can ‘pass it back’ for routing or ‘pass it on’ to another worker, who, in turn, might pass it further (in a manner similar to how new requests are handed off).

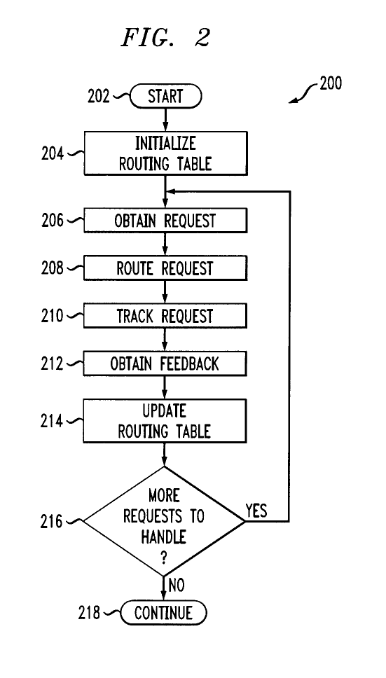

Attention should now be given to FIG. 2, which depicts a flow chart 200 of steps in an exemplary method for routing requests for service, according to an aspect of the invention. After beginning at block 202, optional block 204 includes initializing a routing table 104 based on an organizational structure. Block 206 includes obtaining a plurality of requests 100 for service, each of the requests specifying a description of work, at least one constraint, and at least one objective function. Block 208 includes routing each given one of the requests to a corresponding first target resource 106, according to routing table 104, in a manner to satisfy the at least one constraint and the at least one objective function. Note that in general, the first target resource could be different for each request 100. Block 210 includes tracking whether the first target resource accepts a given request, rejects the given request, or passes on the given request to a second resource.

Optional block 212 includes obtaining feedback from recipients of services corresponding to the requests for service 100. Block 214 includes updating the routing table 104 based on the tracking step 210. Where step 212 is performed, step 214 of updating the routing table is further based on the feedback obtained in step 212.

If there are more requests 100 to handle, as per the “YES” branch of decision block 216, processing flows back to step 206. If no more requests are incoming at present, processing continues at block 218, as per “NO” branch of block 216 (for example, until a further request 100 is received).

The at least one constraint can be, for example, a desired expertise level of a candidate resource to handle a given one of the requests for service; a desired location of a candidate resource to handle a given one of the requests for service; or an availability constraint pertaining to a candidate resource to handle a given one of the requests for service. An availability constraint is one that, for instance, says a resource can only handle X number of requests per time unit.

The at least one objective function can be, for example, a cost function and/or a quality function. The resources can be, for example, individual people (say, individual SMEs) or groups of people (say, work-groups or teams).

In some instances, method 200 can include additional steps (omitted for purposes of illustrative brevity) of identifying key words in the requests for service 100 and weighting the key words according to probabilities that candidate resources 106, 124, 112 can perform at least one of (i) fulfilling (in whole or in part) and (ii) accurately routing a given one of the requests for service 100. A word can be weighted, for example, based on tracking accuracy of routing a request. There are different ways of doing the tracking (and aging the associated tracked information). One possibility is to track the average number of re-routs a request takes before getting resolved. Users along the way are rewarded based on an inverse relationship of the distance to the resolving (end) user. For example, user A re-routes a request to user B, who routes a request to user C. Then A gets rewarded F(2), B get rewarded F(1) and C get rewarded F(0), where F(.) is a reward function.

In some instances, method 200 can include an additional step (omitted for purposes of illustrative brevity) of adjusting the probabilities based on “stochasticity” of an associated work environment. For example, a probability could be adjusted based on load balancing and/or time-of-day availability. The weight computation could include time-of-day or current load. For example, resources located in the US should not have requests routed to them if it is past 5 pm (since such requests will likely not be handled until the following day). By adding time conditions during the computation of weights (assuming, in one or more embodiments, that there are ones (resources) distributed across multiple geographies), then weights are now functions of ‘time,’ making them changing with time. Similarly, load conditions can be included. In some instances, method 200 can includes an additional step (omitted for purposes of illustrative brevity) of adjusting the probabilities based on expected completion time associated with different candidate resources.

### Exemplary System and Article of Manufacture Details

A variety of techniques, utilizing dedicated hardware, general purpose processors, firmware, software, or a combination of the foregoing may be employed to implement the present invention or components thereof. One or more embodiments of the invention, or elements thereof, can be implemented in the form of a computer product including a computer usable medium with computer usable program code for performing the method steps indicated. Furthermore, one or more embodiments of the invention, or elements thereof, can be implemented in the form of an apparatus including a memory and at least one processor that is coupled to the memory and operative to perform exemplary method steps.

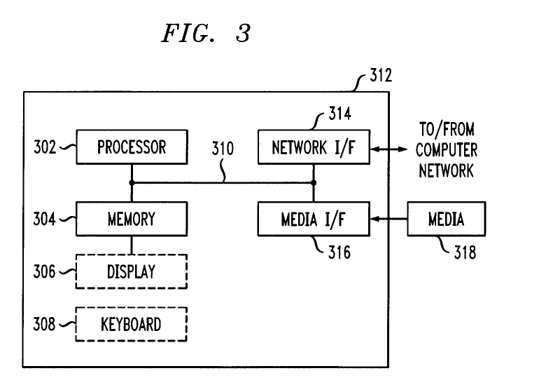

One or more embodiments can make use of software running on a general purpose computer or workstation. With reference to FIG. 3, such an implementation might employ, for example, a processor 302, a memory 304, and an input/output interface formed, for example, by a display 306 and a keyboard 308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 302, memory 304, and input/output interface such as display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 318) providing program code for use by or in connection with a computer or any instruction execution system. For the purposes of this description, a computer usable or computer readable medium can be any apparatus for use by or in connection with the instruction execution system, apparatus, or device. The medium can store program code to execute one or more method steps set forth herein.

The medium can be an electronic, magnetic, optical, electromagnetic, infrared, or semiconductor system (or apparatus or device) or a propagation medium. Examples of a computer-readable medium include a semiconductor or solid-state memory (for example memory 304), magnetic tape, a removable computer diskette (for example media 318), a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor 302 coupled directly or indirectly to memory elements 304 through a system bus 310. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards 308, displays 306, pointing devices, and the like) can be coupled to the system either directly (such as via bus 310) or through intervening I/O controllers (omitted for clarity).

Network adapters such as network interface 314 may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for routing requests for service, said method comprising the steps of:
obtaining a plurality of requests for service, each of said requests specifying a description of work, at least one constraint, and at least one objective function;
routing each given one of said requests to a corresponding first target resource, according to a routing table, in a manner to satisfy said at least one constraint and said at least one objective function;
tracking whether said first target resource accepts a given request, rejects said given request, or passes on said given request to a second resource; and
updating said routing table based on said tracking step.

2. The method of claim 1, wherein said at least one constraint comprises a desired expertise level of a candidate resource to handle a given one of said requests for service.

3. The method of claim 1, wherein said at least one constraint comprises a desired location of a candidate resource to handle a given one of said requests for service.

4. The method of claim 1, wherein said at least one constraint comprises an availability constraint pertaining to a candidate resource to handle a given one of said requests for service.

5. The method of claim 1, wherein said at least one objective function comprises a cost function.

6. The method of claim 1, wherein said at least one objective function comprises a quality function.

7. The method of claim 1, further comprising the additional step of initializing said routing table based on an organizational structure.

8. The method of claim 1, further comprising the additional step of obtaining feedback from recipients of services corresponding to said requests for service, wherein said step of updating said routing table is further based on said feedback.

9. The method of claim 1, wherein said resources comprise individual people.

10. The method of claim 1, wherein at least some of said resources comprise groups of people.

11. The method of claim 1, further comprising the additional steps of:
identifying key words in said requests for service; and
weighting said key words according to probabilities that candidate resources can perform at least one of fulfilling and accurately routing a given one of said requests for service.

12. The method of claim 11, further comprising the additional step of adjusting said probabilities based on stochasticity of an associated work environment.

13. The method of claim 11, further comprising the additional step of adjusting said probabilities based on expected completion time associated with different candidate resources.

14. A computer program product comprising a computer useable medium including computer usable program code for routing requests for service, said computer program product including:
computer usable program code for obtaining a plurality of requests for service, each of said requests specifying a description of work, at least one constraint, and at least one objective function;
computer usable program code for routing each given one of said requests to a corresponding first target resource, according to a routing table, in a manner to satisfy said at least one constraint and said at least one objective function;
computer usable program code for tracking whether said first target resource accepts a given request, rejects said given request, or passes on said given request to a second resource; and
computer usable program code for updating said routing table based on said tracking step.

15. The computer program product of claim 14, wherein said at least one constraint comprises a desired expertise level of a candidate resource to handle a given one of said requests for service.

16. The computer program product of claim 14, wherein said at least one constraint comprises a desired location of a candidate resource to handle a given one of said requests for service.

17. The computer program product of claim 14, wherein said at least one constraint comprises an availability constraint pertaining to a candidate resource to handle a given one of said requests for service.

18. A system for routing requests for service, said system comprising:
a memory; and
at least one processor, coupled to said memory, and operative to
obtain a plurality of requests for service, each of said requests specifying a description of work, at least one constraint, and at least one objective function;
route each given one of said requests to a corresponding first target resource, according to a routing table, in a manner to satisfy said at least one constraint and said at least one objective function;
track whether said first target resource accepts a given request, rejects said given request, or passes on said given request to a second resource: and
update said routing table based on said tracking.

19. The system of claim 18, wherein said at least one constraint comprises a desired expertise level of a candidate resource to handle a given one of said requests for service.

20. The system of claim 18, wherein said at least one constraint comprises a desired location of a candidate resource to handle a given one of said requests for service.

21. The system of claim 18, wherein said at least one constraint comprises an availability constraint pertaining to a candidate resource to handle a given one of said requests for service.

22. A system for routing requests for service, said system comprising:
means for obtaining a plurality of requests for service, each of said requests specifying a description of work, at least one constraint, and at least one objective function;
means for routing each given one of said requests to a corresponding first target resource, according to a routing table, in a manner to satisfy said at least one constraint and said at least one objective function;
means for tracking whether said first target resource accepts a given request, rejects said given request, or passes on said given request to a second resource; and
means for updating said routing table based on said tracking performed by said tracking means.

23. The system of claim 22, wherein said at least one constraint comprises a desired expertise level of a candidate resource to handle a given one of said requests for service.

24. The system of claim 22, wherein said at least one constraint comprises a desired location of a candidate resource to handle a given one of said requests for service.

25. The system of claim 22, wherein said at least one constraint comprises an availability constraint pertaining to a candidate resource to handle a given one of said requests for service.
